(19) United States
(12) Patent Application Publication
(10) Pub. No.: US 2026/0315884 A1
(43) Pub. Date: Oct. 15, 2026

(54) GOLF CLUB HEAD

(71) Applicant: SUMITOMO RUBBER INDUSTRIES, LTD., Kobe-shi (JP)

(72) Inventors: Naruhiro MIZUTANI, Kobe-shi (JP); Daisuke KOHNO, Kobe-shi (JP); Takashi ONO, Kobe-shi (JP)

(73) Assignee: SUMITOMO RUBBER INDUSTRIES, LTD., Kobe-shi (JP)

(21) Appl. No.: 19/462,440

(22) Filed: Jan. 28, 2026

(30) Foreign Application Priority Data
Jan. 29, 2025 (JP) 2025-13280

(51) Int. Cl. A63B 53/04

(52) U.S. Cl. CPC A63B 53/0416; A63B 53/0466

(57) ABSTRACT

A golf club head includes a body member and a face member. The face member includes a striking face region that includes a sweet spot, and a peripheral region that surrounds an entirety of the striking face region. The peripheral region of the face member includes a neck region that forms a heel-side portion of the peripheral region, that extends continuously from the striking face region, and that has a curved shape that is convex frontward. In a horizontal cross section that passes through the sweet spot, a distance in a toe-heel direction between a toe-most point of the striking face region and a center line of a hosel hole is defined as length L, a length of the striking face region in the toe-heel direction is defined as length F, and a ratio of length F to length L is 80% or more.

### CROSS REFERENCE TO RELATED APPLICATION

The present application claims priority to Japanese Patent Application No. 2025-13280 filed on Jan. 29, 2025. The entire contents of this Japanese Patent Application are hereby incorporated by reference.

### BACKGROUND

### Technical Field

The present disclosure relates to golf club heads.

### Description of the Related Art

A golf club head including a face member and a head body (body member) that are joined to each other has been known. To produce the head, different materials can be used for the face member and the head body (body member). JP 3188115 U discloses a golf club head including a face member and a head body that are joined to each other. JP 3188115 U shows, in FIG. 4(a) and FIG. 5(a), a face member that includes a beveled portion on its upper heel side for avoiding a neck portion.

### SUMMARY

The inventors of the present disclosure have found that the rebound performance of the above-described head structure can be improved. One of the objectives of the present disclosure is to provide a golf club head having a new structure that includes a face member and a body member and that exhibits enhanced rebound performance.

In one aspect, a golf club head includes a body member and a face member. The body member includes an opening that is formed in a front portion of the body member, and a hosel portion that includes a hosel hole. The face member is joined to the body member to cover the opening of the body member. The face member includes a striking face region that includes a sweet spot, and a peripheral region that surrounds an entirety of the striking face region. The striking face region constitutes a curved surface that is convex frontward and that has a radius of curvature of greater than or equal to 200 mm. The peripheral region of the face member includes a neck region that forms a heel-side portion of the peripheral region, that extends continuously from the striking face region, and that has a curved shape that is convex frontward. In a horizontal cross section that passes through the sweet spot and that is taken when the golf club head is in a reference state, a distance in a toe-heel direction between a toe-most point of the striking face region and a center line of the hosel hole is defined as a length L, a length of the striking face region in the toe-heel direction is defined as a length F, and a ratio of the length F to the length L is greater than or equal to 80%.

### BRIEF DESCRIPTION OF THE DRAWINGS

FIG. 1 is a plan view of a golf club head according to an embodiment, and FIG. 1 shows a planar view of the head;

FIG. 2 is a front view of the head in FIG. 1, and FIG. 2 shows a front elevation view of the head;

FIG. 3 is a perspective view of the head in FIG. 1;

FIG. 4 is an exploded perspective view of the head in FIG. 1;

FIG. 5 is a cross-sectional view taken along line A-A in FIG. 2;

FIG. 6 is an enlarged view of the front view in FIG. 2;

FIG. 7 is a partially enlarged view of FIG. 6;

FIG. 8 is a plan view of a head according to a reference example; and

FIG. 9 is a conceptual diagram for illustrating a reference state.

### DESCRIPTION OF THE PREFERRED EMBODIMENTS

Hereinafter, the present disclosure will be described in detail based on preferred embodiments with appropriate references to the accompanying drawings. The same or corresponding elements in the following embodiments are denoted by the same reference symbols. Repeated explanations are omitted as appropriate.

In the present disclosure, a reference state, a toe-heel direction, a face-back direction, an up-down direction, a sweet spot, a planar view, a front elevation view, a radial cross section, a horizontal cross section, and a vertical cross section are defined.

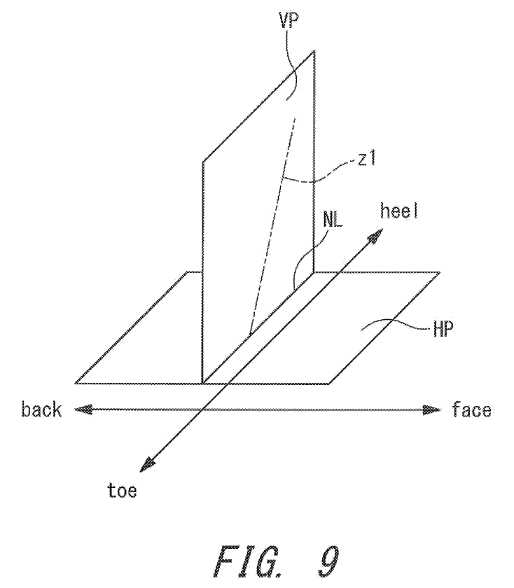

The reference state is defined as a state where a head is placed at a predetermined lie angle on a ground plane HP. As shown in FIG. 9, in the reference state, a hosel axis line z1 lies on (is contained in) a plane VP that is perpendicular to the ground plane HP. The hosel axis line z1 is defined as the center line of a hosel hole. In a normal head, the hosel axis line z1 can coincide with a shaft axis line.

Some golf club heads include a sleeve that is fixed to a tip portion of a shaft and that is inserted into the hosel hole, the sleeve enabling attachment and detachment of the shaft. In such golf club heads, three adjustment parameters, namely loft angle, lie angle, and face angle, can be adjusted by changing the rotational position of the sleeve. In this configuration, since a shaft hole formed in the sleeve is inclined relative to the hosel hole, the hosel axis line z1 does not coincide with the shaft axis line. In such golf club heads, a dedicated sleeve in which the shaft hole is not inclined relative to the hosel hole can be prepared so that the shaft axis line coincides with the hosel axis line z1.

When a head is in the reference state, the face angle is 0°. That is, in a planar view of the head as viewed from above, a tangent line to the head at its sweet spot is set to be parallel to the toe-heel direction.

The toe-heel direction is defined as the direction of an intersection line NL between the ground plane HP and the plane VP that contains the hosel axis line z1 and is perpendicular to the ground plane HP (see FIG. 9).

The face-back direction is defined as a direction that is perpendicular to the toe-heel direction and is parallel to the ground plane HP. The face side in the face-back direction is also simply referred to as “face side” or “front side”. The back side in the face-back direction is also simply referred to as “back side” or “rear side”.

The up-down direction is defined as a direction that is perpendicular to the toe-heel direction and perpendicular to the face-back direction. In other words, the up-down direction in the present disclosure is a direction perpendicular to the ground plane HP. As used herein, “upper” in the up-down direction is also referred to as “above”, and “lower” in the up-down direction is also referred to as “below”.

The sweet spot is defined as an intersection point between a striking face and a straight line that passes through the center of gravity of the head and is perpendicular to the striking face.

The planar view is defined as a view of a head as viewed from above when the head is in the reference state. In other words, the planar view refers to a projected figure of a head obtained by projecting the head which is in the reference state onto a plane parallel to the ground plane HP. The direction of the projection is perpendicular to the plane on which the head is projected. In other words, the direction of the projection is the up-down direction.

The front elevation view is defined as a view of a head as viewed from the front side when the head is in the reference state. In other words, the front elevation view refers to a projected figure of a head obtained by projecting the head which is in the reference state onto a plane parallel to the plane VP. The direction of the projection is perpendicular to the plane on which the head is projected. In other words, the direction of the projection is the face-back direction.

The radial cross section is defined as a cross section taken along a flat plane that contains a straight line connecting the sweet spot and the center of gravity of the head. A plurality of such flat planes can be defined at respective rotational positions about the straight line. Thus, a large number of the flat planes can be defined, and the corresponding radial cross sections can be obtained.

The horizontal cross section is defined as a cross section that is taken along a flat plane parallel to the ground plane HP when the head is in the reference state. A plurality of such flat planes can be defined at respective positions along the up-down direction. Thus, a large number of the flat planes can be defined, and the corresponding horizontal cross sections can be obtained.

The vertical cross section is defined as a cross section that is taken along a flat plane perpendicular to the toe-heel direction when the head is in the reference state. A plurality of such flat planes can be defined at respective positions along the toe-heel direction. Thus, a large number of the flat planes can be defined, and the corresponding vertical cross sections can be obtained.

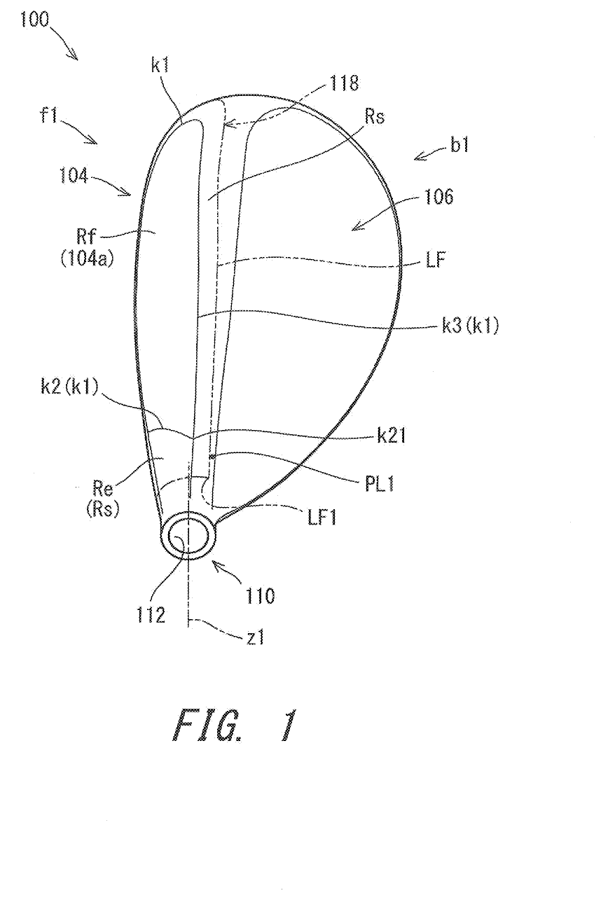

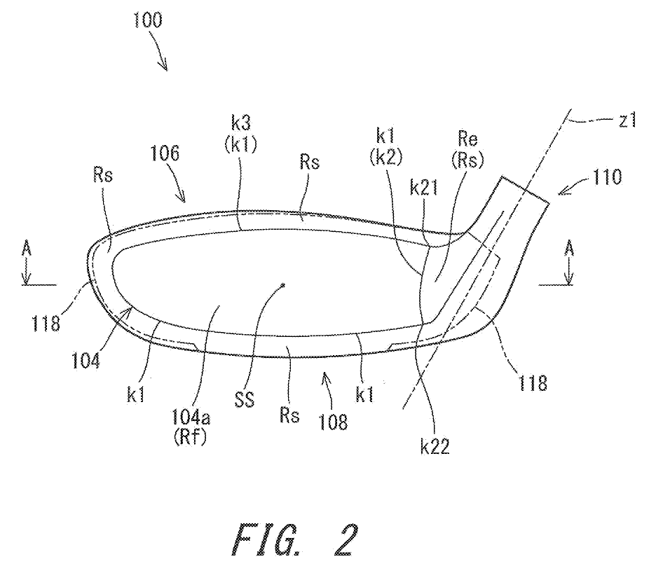

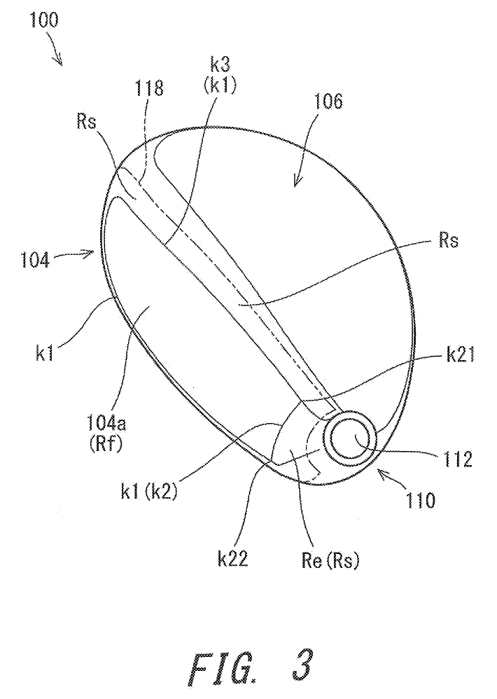

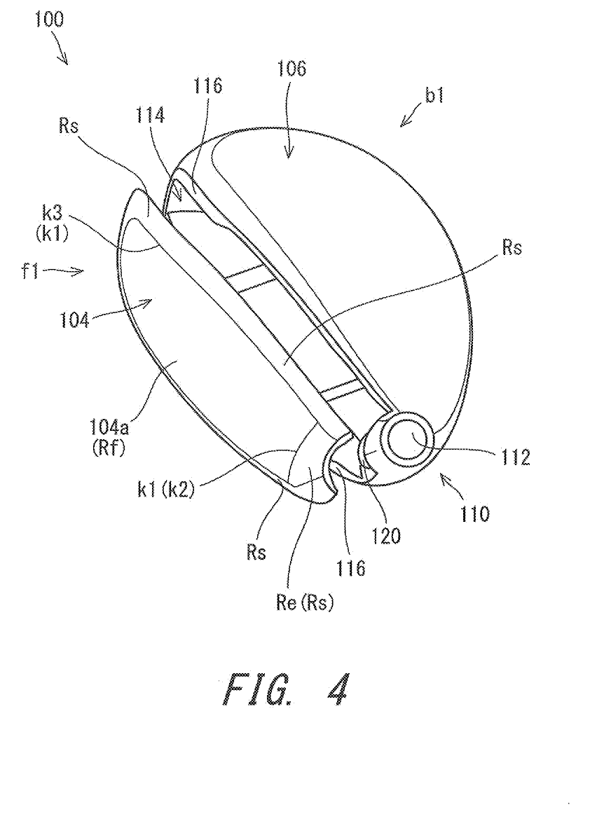

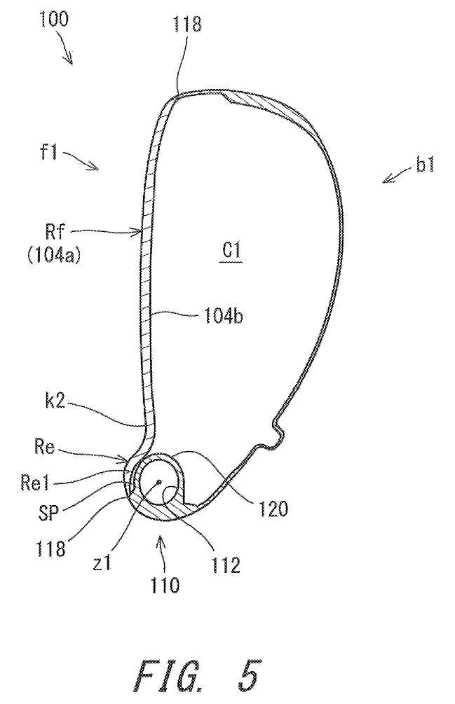

FIG. 1 is a plan view of a golf club head 100 according to one embodiment. FIG. 2 is a front view of the head 100. FIG. 3 is a perspective view of the head 100. FIG. 4 is an exploded perspective view of the head 100. FIG. 5 is a cross-sectional view taken along line A-A in FIG. 2. FIG. 1 shows the planar view of the head 100. FIG. 2 shows the front elevation view of the head 100. FIG. 5 shows an example of the horizontal cross section of the head 100.

The head 100 includes a face portion 104, a crown portion 106, a sole portion 108, and a hosel portion 110. The face portion 104 includes a striking face 104aand a face inner surface 104b. The striking face 104ais the outer surface (front surface) of the face portion 104. The face inner surface 104bis the inner surface (rear surface) of the face portion 104.

The striking face 104a includes an outer edge k1. The outer edge k1 is the contour line of the striking face 104a. The outer edge k1 is the boundary between the striking face 104a and its adjacent portions.

A region in which the striking face 104a is located is also referred to as a striking face region Rf. The outer edge k1 is the boundary between the striking face region Rf and its adjacent region. The striking face region Rf is defined (surrounded) by the outer edge k1. The striking face region Rf includes a sweet spot SS (see FIG. 2). The striking face region Rf is configured to strike a golf ball.

The striking face region Rf (striking face 104a) includes a bulge and a roll. The bulge refers to the curvature (roundness) in the horizontal direction. In other words, the bulge refers to the curvature (roundness) shown in the horizontal cross section (see FIG. 5). The roll refers to the curvature (roundness) in the vertical direction (up-down direction). In other words, the roll refers to the curvature (roundness) shown in the vertical cross section. Due to the bulge curvature and roll curvature, the striking face region Rf constitutes a curved surface that is convex frontward.

The hosel portion 110 includes a hosel hole 112. In the head of the present embodiment, a shaft is directly inserted into and fixed to the hosel hole 112. Alternatively, as described above, a sleeve attached to the tip portion of the shaft may be inserted into and fixed to the hosel hole 112.

As shown in FIG. 5, the head 100 includes a hollow interior C1. The head 100 is a hollow head. The head 100 is a hybrid type head. Alternatively, the head 100 may be a fairway wood type head. Further alternatively, the head 100 may be a driver head. From the viewpoints described later, the head 100 is preferably a fairway wood type head or a hybrid type head.

From the viewpoint of constituent members, the head 100 includes a face member f1 and a body member b1 (see FIG. 4). The face member f1 is joined to the body member b1. As shown in FIG. 4, the body member b1 includes an opening 114 formed in its front portion. The opening 114 is covered by the face member f1.

As shown in FIG. 4, the body member b1 includes a joint surface 116. The joint surface 116 forms a front end surface of the body member b1. The joint surface 116 is located around the opening 114. The body member b1 is joined to the face member f1 at the joint surface 116. In the present embodiment, the body member b1 is joined to the face member f1 by welding.

A boundary 118 between the body member b1 and the face member f1 is formed on the outer surface of the head 100. The boundary 118 also forms the contour line of the face member f1. The boundary 118 is indicated by a dash-dot-dot-dash line in the drawings. When the body member b1 is welded to the face member f1 as in the present embodiment, the welding is performed at the boundary 118 (hereinafter, such a portion where welding is performed is also referred to as a welded portion). A weld bead is formed on the boundary 118 during the welding process. The weld bead formed on the outer surface of the head 100 is removed by polishing. The polishing achieves a smooth outer surface at the boundary 118 of the head 100. A smooth and continuous curved surface is formed at the boundary 118. In the head 100 as a completed product that has undergone surface finishing including painting, the boundary 118 is not visible.

The face member f1 is a cup-shaped member as a whole that includes a bottom portion forming the face portion 104. The face member f1 includes the entirety of the striking face 104a. That is, the face member f1 includes the entirety of the striking face region Rf. The face member f1 also includes a peripheral region Rs that surrounds the entirety of the striking face region Rf. The peripheral region Rs is located between the outer edge k1 and the boundary 118. Alternatively, the face member f1 does not have to have a cup shape.

The peripheral region Rs includes a neck region Re. The neck region Re forms a heel-side portion of the peripheral region Rs. The neck region Re extends continuously from the striking face region Rf. As shown in FIG. 5, the neck region Re has a curved shape that is convex frontward. The curved shape of the neck region Re is smoothly continuous with the hosel portion 110. As described later, the neck region Re may include a portion having a curved shape that is convex rearward.

As shown in FIG. 5, the hosel portion 110 includes a hosel inner wall portion 120 that is located inside the head 100. The hosel inner wall portion 120 is a wall portion that forms part of the wall defining the hosel hole 112 and that faces the hollow interior C1. The hosel inner wall portion 120 forms a substantially cylindrical wall portion inside the head 100. The hosel inner wall portion 120 is part of the body member b1. The neck region Re includes an inner wall front portion Re1 that is located on the front side relative to the hosel inner wall portion 120. The inner wall front portion Re1 has a curved shape that is convex frontward. A gap SP is formed between the inner wall front portion Re1 and the hosel inner wall portion 120. The gap SP contributes to improved rebound performance. The neck region Re is curved to avoid the hosel inner wall portion 120. The neck region Re has a curved shape that is convex frontward and that follows the contour line of the hosel inner wall portion 120. The gap SP is formed between the neck region Re and the hosel inner wall portion 120. The neck region Re of the face member f1 extends to reach a position that is located on the heel side relative to the hosel axis line z1 (see FIGS. 5 and 2).

The striking face region Rf includes a heel-side edge k2 at which the striking face region Rf transitions into the neck region Re. The heel-side edge k2 is part of the outer edge k1 of the striking face region Rf. The heel-side edge k2 can be defined by an inflection point on the contour line of the striking face 104a in a horizontal cross section (see FIG. 5). Inflection points are determined in respective horizontal cross sections, and a set of these inflection points can be defined as the heel-side edge k2.

As shown in FIG. 5, the striking face region Rf is smoothly continuous with the neck region Re. The striking face region Rf forms a curved surface that is convex frontward, and the neck region Re also forms a curved surface that is convex frontward. A curved surface that is convex rearward may be present between these frontward-convex curved surfaces. Accordingly, two (or more) inflection points can be present on the contour line of the striking face 104a in a horizontal cross section. In this configuration, among the plurality of inflection points, the inflection point located at the toe-most position (the toe-most inflection point) can form the heel-side edge k2. The neck region Re includes the curved surface that is convex rearward and that is located on the heel side relative to the toe-most inflection point.

As described above, the striking face region Rf is a curved surface that is convex frontward. The striking face region Rf has a radius of curvature of greater than or equal to 200 mm. In each of the radial cross sections, when a radius of curvature of the cross-sectional contour line of the head outer surface is sequentially observed from the sweet spot SS toward the outside of the striking face 104a, a point at which the radius of curvature reaches 200 mm for the first time is determined. A set of these points can be defined as the outer edge k1 of the striking face region Rf. However, in the heel-side portion of the striking face region Rf, the radius of curvature may not decrease to 200 mm. That is, the radius of curvature may not be reduced to 200 mm in a portion connected to the hosel portion 110. In the heel-side portion of the striking face region Rf, the heel-side edge k2 can also serve as the outer edge k1 of the striking face region Rf. To determine the outer edge k1, the heel-side edge k2 can be preferentially defined as the outer edge k1. For the remaining portion other than the heel-side edge k2, a point having a radius of curvature of 200 mm can be defined as the outer edge k1 as described above.

As shown in FIG. 2, the heel-side edge k2 extends substantially in the up-down direction. The heel-side edge k2 is curved to be convex toward the toe side. The heel-side edge k2 is the boundary between the striking face region Rf and the neck region Re.

The heel-side edge k2 includes an upper end k21 and a lower end k22. The heel-side edge k2 intersects at the upper end k21 with a portion of the outer edge k1 that does not coincide with the heel-side edge k2. The upper end k21 is the intersection point between a face upper edge k3 and the heel-side edge k2. The face upper edge k3 is described in detail later. The heel-side edge k2 intersects at the lower end k22 with a portion of the outer edge k1 that does not coincide with the heel-side edge k2. The outer edge k1 has a closed shape with no gap. Alternatively, the outer edge k1 may include one or more gaps.

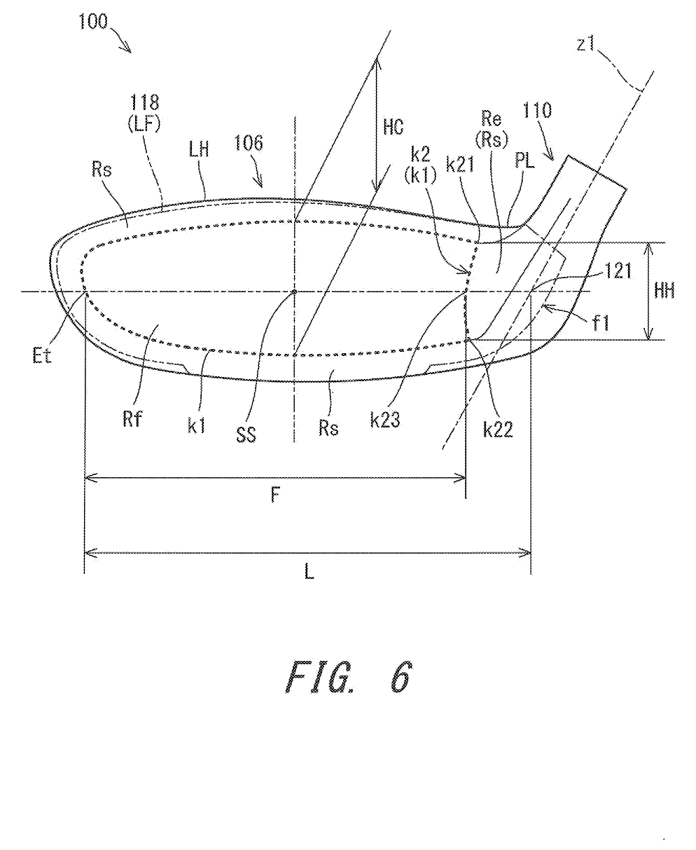

FIG. 6 is an enlarged view of FIG. 2. In FIG. 6, the outer edge k1 of the striking face region Rf is indicated by a thick dashed line. A portion surrounded by this thick dashed line is the striking face region Rf.

The face member f1 has a length L. The length L is defined as a distance from a toe-most point Et of the striking face region Rf to the hosel axis line z1 in the horizontal cross section passing through the sweet spot SS. In other words, the length L is defined as a distance between the toe-most point Et and an intersection point 121. The intersection point 121 refers to an intersection point between the hosel axis line z1 and the horizontal cross section passing through the sweet spot SS as viewed in the front elevation view. The length L is measured in the toe-heel direction. The face member f1 includes the intersection point 121 as viewed in the front elevation view. The face member f1 extends to reach a position that is located on the heel side relative to the intersection point 121.

The striking face region Rf has a length F. The length F is defined as a length of the striking face region Rf in the horizontal cross section passing through the sweet spot SS. In other words, the length F is defined as a distance between the toe-most point Et and a point k23 that is located on the heel-side edge k2. The point k23 refers to an intersection point between the heel-side edge k2 and the horizontal cross section passing through the sweet spot SS. The length F is measured in the toe-heel direction.

In the head 100, a ratio of the length F to the length L is large. The ratio of the length F to the length L is greater than or equal to 80%.

The upper end k21 of the heel-side edge k2 is located on the heel side relative to the point k23. The lower end k22 of the heel-side edge k2 is located on the heel side relative to the point k23.

The striking face region Rf has a length HC. The length HC is defined as a length of the striking face region Rf in the vertical cross section passing through the sweet spot SS. The length HC is measured in the up-down direction.

The striking face region Rf has a length HH. The length HH is defined as a length of the heel-side edge k2 in the up-down direction. In other words, the length HH is defined as a distance between the upper end k21 and the lower end k22 in the up-down direction.

In the present embodiment, a ratio of the length HH to the length HC is large. In the head 100, the ratio of the length HH to the length HC is greater than or equal to 65%.

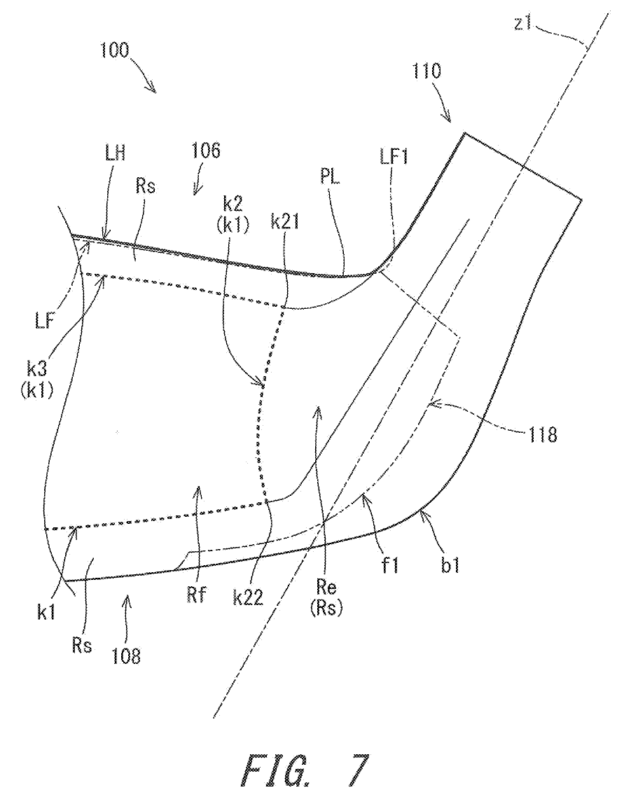

FIG. 7 is a partially enlarged view of FIG. 6. In the front elevation view of the head 100, a portion of the contour line of the head 100 that is located on the crown side is defined as a crown-side contour line LH. In FIG. 7, the crown-side contour line LH is indicated by a thick solid line. The crown-side contour line LH may be formed by a portion of the contour line of the face member f1 and/or a portion of the contour line of the body member b1.

A portion of the contour line of the face member f1 that is located on the crown side is defined as an upper contour line LF. The upper contour line LF either follows the crown-side contour line LH or coincides with the crown-side contour line LH. When the contour line of the face member f1 forms a portion of the crown-side contour line LH, the crown-side contour line LH coincides with the upper contour line LF in that portion.

In the front elevation view of the head 100, the crown-side contour line LH has a lowest point PL. The lowest point PL is located at or in the vicinity of the boundary between the crown portion 106 and the hosel portion 110. The lowest point PL may be located on either the contour line of the face member f1 or the contour line of the body member b1. In the present embodiment, the lowest point PL is located on the contour line of the body member b1. However, the crown-side contour line LH substantially coincides with the upper contour line LF at the position of the lowest point PL. At the position of the lowest point PL, a distance between the crown-side contour line LH and the upper contour line LF can be less than or equal to 1.5 mm, can further be less than or equal to 1 mm, and can even further be less than or equal to 0.5 mm. This distance is measured in the up-down direction in the front elevation view of the head 100.

The neck region Re extends to traverse the position of the lowest point PL in the toe-heel direction. In other words, the neck region Re extends from a position located on the toe side relative to the lowest point PL to a position located on the heel side relative to the lowest point PL. The upper contour line LF of the face member f1 extends from a position located on the toe side relative to the lowest point PL to a position located on the heel side relative to the lowest point PL.

The neck region Re extends to traverse the position of the lowest point PL in the up-down direction. In other words, a portion of the neck region Re that is located on the heel side relative to the lowest point PL extends to reach a position located on the upper side relative to the lowest point PL. A portion of the upper contour line LF of the face member f1 that is located on the heel side relative to the lowest point PL extends to reach a position located on the upper side relative to the lowest point PL. A heel-side end LF1 of the upper contour line LF is located on the upper heel side relative to the lowest point PL.

The lowest point PL is indicated in the front elevation view, which is a two-dimensional drawing.

A point corresponding to the lowest point PL on an actual head can be specified as an actual point on the outer surface of the head 100. This actual point is also referred to as a corresponding lowest point. For example, a straight ruler aligned parallel to the face-back direction can be brought into contact with the head 100 at a position corresponding to the lowest point PL as viewed in the front elevation view. The corresponding lowest point can be defined as a point at which the straight ruler makes contact with the outer surface of the head 100. When the straight ruler makes line contact with the outer surface of the head 100, a front end of this contact line can be defined as the corresponding lowest point. The corresponding lowest point can also be defined as an upper-most point of the head 100 in a vertical cross section passing through the lowest point PL. The corresponding lowest point is a point that is located on the outer surface of the head 100 and that corresponds to the lowest point PL.

FIG. 1 shows the corresponding lowest point, denoted by PL1, which corresponds to the lowest point PL. In the present embodiment, the corresponding lowest point PL1 is located on the body member b1. The face member f1 extends to reach a position located on the heel side relative to the corresponding lowest point PL1. The corresponding lowest point PL1 is located on the toe side relative to the heel-side end LF1 of the upper contour line LF. The corresponding lowest point PL1 is located on or in the vicinity of the upper contour line LF of the face member f1. A distance between the upper contour line LF and the corresponding lowest point PL1 can be less than or equal to 2 mm, can further be less than or equal to 1.5 mm, and can even further be less than or equal to 1 mm. This distance is measured in the face-back direction in the planar view of the head 100. The corresponding lowest point PL1 is located on the heel side relative to the upper end k21 of the heel-side edge k2.

The outer edge k1 of the striking face region Rf includes the face upper edge k3. The face upper edge k3 is defined as a boundary between the striking face region Rf and a portion of the peripheral region Rs that is located on the upper side of the striking face region Rf. The face upper edge k3 and/or its vicinity may be perceived by golfers as a top line. A heel-side end of the face upper edge k3 coincides with the upper end k21 of the heel-side edge k2. The face upper edge k3 does not intersect the boundary 118.

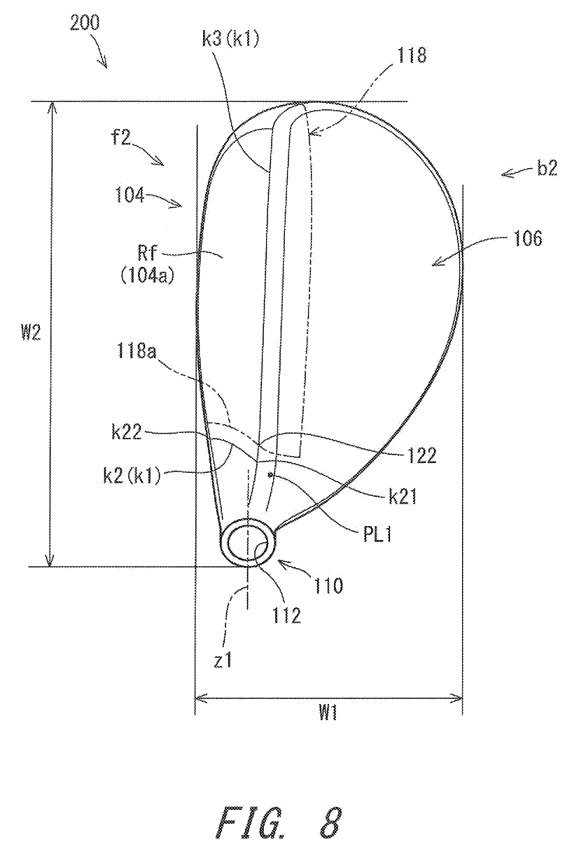

FIG. 8 is a plan view of a head 200 according to a reference example.

A face member f2 and a body member b2 are welded to each other to form the head 200. The face member f2 of the head 200 is a cup-shaped member as a whole that includes a bottom portion forming the face portion 104. The outer edge of the face member f2 is defined as a boundary 118 between the face member f2 and the body member b2. The external shape of the head 200 is the same as the external shape of the head 100.

Unlike the face member f1 of the head 100, the face member f2 does not include the entirety of the striking face 104a. That is, the face member f2 does not include the entirety of the striking face region Rf. A heel-side portion of the striking face region Rf is not included in the face member f2. The heel-side edge k2 of the striking face region Rf is not included in the face member f2. The entirety of the heel-side edge k2 is excluded from the face member f2.

The contour line 118 of the face member f2 includes a heel-side edge 118a. The heel-side edge 118ais located on the toe side relative to the heel-side edge k2 of the striking face region Rf. A portion of the striking face region Rf is located on the heel side of the heel-side edge 118a. The face member f2 does not include a neck region Re that extends continuously from the striking face region Rf and has a curved shape that is convex frontward.

The face upper edge k3 intersects the contour line 118 of the face member f2. In other words, the welded portion 118 intersects the face upper edge k3. The face upper edge k3 intersects the heel-side edge 118aof the face member f2. FIG. 8 shows an intersection point 122 between the face upper edge k3 and the contour line 118 (heel-side edge 118a).

The corresponding lowest point PL1 is located on the body member b2. The face member f2 does not extend to reach a position of the corresponding lowest point PL1 in the toe-heel direction. The entirety of the face member f2 is located on the toe side relative to the corresponding lowest point PL1. The heel-side edge 118aof the face member f2 is located on the toe side relative to the corresponding lowest point PL1.

The head 100 of the above-described embodiment exhibits the following advantageous effects.

The face member f1 includes the striking face region Rf and the peripheral region Rs surrounding the entirety of the striking face region Rf. Although rigidity can increase at a joint portion at which the face member f1 is joined to the body member b1, no joint portion is present in the striking face region Rf. This configuration facilitates the bending of the entirety of the striking face region Rf, which can enhance the rebound performance of the head 100.

The peripheral region Rs of the face member f1 includes the neck region Re which forms a heel-side portion of the peripheral region Rs. The neck region Re extends continuously from the striking face region Rf and has a curved shape that is convex frontward. The face member f1 including the neck region Re further facilitates the bending of the heel-side portion of the face member f1. This configuration can further enhance the rebound performance of the head 100 and can extend a high rebound area to the heel-side portion.

As discussed with reference to FIG. 6, in the horizontal cross section of the face member f1 passing through the sweet spot SS, a distance in the toe-heel direction from the toe-most point Et of the striking face region Rf to the center line z1 of the hosel hole 112 is defined as the length L. Additionally, in the horizontal cross section of the face member f1 passing through the sweet spot SS, the length of the striking face region Rf in the toe-heel direction is defined as the length F. In the head 100, the ratio of the length F to the length L is greater than or equal to 80%. The length F is relatively large in relation to the length L, which can further facilitate the bending of the heel-side portion of the face member f1. This configuration can further enhance the rebound performance of the head 100 and can extend a high rebound area to the heel-side portion. Additionally, extending the striking face region Rf to the heel side increases the striking area on the heel side, which can help prevent missed shots, such as so-called shanks.

From the viewpoint of extending the high rebound area to the heel side and preventing missed shots, the ratio of the length F to the length L is preferably greater than or equal to 80%, more preferably greater than or equal to 81%, and even more preferably greater than or equal to 82%. From the viewpoint of ensuring sufficient dimensions for the neck region Re in the face member f1, the ratio of the length F to the length L is preferably less than or equal to 96%, more preferably less than or equal to 95%, and even more preferably less than or equal to 94%.

The length F is measured in the horizontal cross section passing through the sweet spot SS. The above-described advantageous effects can be further enhanced by locating the entirety of the heel-side edge k2 at a further heel-side position not only in the horizontal cross section passing through the sweet spot SS but also in all horizontal cross sections passing through the heel-side edge k2. From the viewpoint of further enhancing the

advantageous effects of extending the striking area to the heel side and preventing missed shots, the following configuration is preferable. In all horizontal cross sections passing through the heel-side edge k2, the ratio of the distance in the toe-heel direction between the toe-most point Et of the striking face region Rf and the heel-side edge k2 to the length L is preferably greater than or equal to 83%, more preferably greater than or equal to 84%, and even more preferably greater than or equal to 85%. From the viewpoint of forming the neck region Re, in all horizontal cross sections passing through the heel-side edge k2, the ratio of the distance in the toe-heel direction between the toe-most point Et of the striking face region Rf and the heel-side edge k2 to the length L is preferably less than or equal to 97%, more preferably less than or equal to 96%, and even more preferably less than or equal to 95%.

As described above, the length of the heel-side edge k2 in the up-down direction is defined as the length HH (see FIG. 6). Additionally, the length of the striking face region Rf in the up-down direction in the vertical cross section passing through the sweet spot SS is defined as the length HC. From the viewpoint of further enhancing the advantageous effects of extending the striking area to the heel side and preventing missed shots, the length HH of the heel-side edge k2 in the up-down direction is preferably large. From this viewpoint, the ratio of the length HH to the length HC is preferably greater than or equal to 65%, more preferably greater than or equal to 67%, and even more preferably greater than or equal to 70%. An excessively large length HH relative to the length HC can cause golfers to feel a sense of incongruity in the shape of the head. From this viewpoint, the ratio of the length HH to the length HC is preferably less than or equal to 90%, more preferably less than or equal to 88%, and even more preferably less than or equal to 86%.

From the viewpoint of expanding the striking area in hybrid type heads or fairway wood type heads, the length HC is preferably greater than or equal to 18 mm, more preferably greater than or equal to 19 mm, and even more preferably greater than or equal to 20 mm. Considering the impact position between a golf ball and the striking face of hybrid type heads or fairway wood type heads that are often used to strike a golf ball placed directly on the ground, the length HC is preferably less than or equal to 35 mm, more preferably less than or equal to 34 mm, and even more preferably less than or equal to 33 mm.

From the viewpoint of expanding the striking area in hybrid type heads or fairway wood type heads, the length L is preferably greater than or equal to 75 mm, more preferably greater than or equal to 78 mm, and even more preferably greater than or equal to 80 mm. Considering standard head dimensions of hybrid type heads or fairway wood type heads, the length L is preferably less than or equal to 90 mm, more preferably less than or equal to 89 mm, and even more preferably less than or equal to 88 mm.

In the front elevation view (FIG. 6), the face member f1 includes the intersection point 121 between the hosel axis line z1 and the horizontal cross section passing through the sweet spot SS. The face member f1 extends to reach the position of the intersection point 121, which can further facilitate the bending of the heel-side portion of the striking face region Rf. As a result, the rebound performance of the head 100 can be enhanced, and the high rebound area can be further extended to the heel side.

In the head 200 of the reference example shown in FIG. 8, the face member f2 is formed to avoid the neck portion. The face member f2 does not include a neck region Re. The heel-side edge 118aof the face member f2 is located on the toe side relative to the heel-side edge k2 of the striking face region Rf. Accordingly, the heel-side portion of the striking face region Rf is less likely to bend compared to the head 100 of the first embodiment. As a result, the rebound performance is lower, and the high rebound area is not extended to the heel side. The head 100 of the above-described embodiment is superior to the head 200.

In the front elevation view (FIG. 6), a portion of the contour line of the head 100 that is located on the crown side is defined as the crown-side contour line LH, and the crown-side contour line LH has the lowest point PL located on the heel side. As shown in FIG. 7, the neck region Re of the face member f1 extends to reach a position located on the heel side relative to the lowest point PL, and a portion of the neck region Re that is located on the heel side relative to the lowest point PL extends to reach a position located on the upper side relative to the lowest point PL. When the face member f1 is joined to the body member b1 by welding, a weld bead is formed at the boundary 118 between the body member b1 and the face member f1 during the manufacturing process of the head 100. From the viewpoint of the appearance of the head 100, the weld bead needs to be removed by polishing. Since the face member f1 extends as described above, a distance between the weld bead (boundary 118) and the top line increases. As described above, the top line refers to the face upper edge k3 or its vicinity (see FIG. 1). The boundary 118 does not intersect the face upper edge k3. This configuration can minimize the need for polishing on or in the vicinity of the top line. As a result, the shape of the top line is stabilized, and the sense of incongruity in the appearance of the head 100 when addressing a golf ball can be reduced.

As shown in FIG. 8, in the head 200 of the reference example, the heel-side edge 118aof the face member f2 is located on the toe side relative to the upper end k21 of the heel-side edge k2 of the striking face region Rf. The boundary 118 between the body member b2 and the face member f2 (the heel-side edge 118aof the face member f2) intersects the face upper edge k3 at the intersection point 122. This configuration of the head 200 increases the need for polishing on or in the vicinity of the top line. This tends to result in an unstable shape of the top line compared to the head 100, and the sense of incongruity in the appearance of the head 200 when addressing a golf ball can be increased. The head 100 is superior to the head 200.

Due to the loft angle, the striking face region Rf extends backward as it goes upward. Because the striking face region Rf extends to the back side, the neck region of the hosel portion 110 protrudes frontward. As the loft angle increases, the neck region protrudes frontward to a greater extent. As in the head 200 of the reference example, when the face member is formed to avoid the neck region, the face member is prevented from extending to the heel side. This configuration can reduce the degree of deformation of the face member, which can reduce the coefficient of restitution of the head. In the head 100 of the above-described embodiment, the face member f1 extends to include the neck region Re, which can increase the degree of deformation of the face member f1 and can enhance the coefficient of restitution of the head 100. This advantageous effect is more significant in a head in which the neck region Re protrudes frontward to a greater extent. From this viewpoint, the head 100 is preferably a hybrid type head or a fairway wood type head, and more preferably a hybrid type head.

The face member f1 is made of a metal. Examples of the metal include stainless steel, maraging steel, titanium alloys, aluminum alloys, and magnesium alloys. A part of the face member f1 may be made of a non-metal material. For example, a part of the face member f1 may be made of a carbon fiber reinforced resin. However, from the viewpoint of enabling welding between the face member f1 and the body member b1, at least a portion of the face member f1 that is welded to the body member b1 is preferably made of a metal. Examples of the preferable metal material for the face member f1 include titanium alloys and maraging steel. There is no limitation on the method for producing the face member f1. From the viewpoint of strength, the face member f1 may be produced by pressing a plate material. A rolled material may be used as the plate material. Rolled materials have few defects and high strength. In addition, rolled materials are formed with high thickness accuracy. The use of a rolled material improves the accuracy of the wall thickness of the face portion 104. Alternatively, the face member f1 may be produced by forging, for example. Further alternatively, the face member f1 may be produced by casting.

The body member b1 is made of a metal. Examples of the metal include stainless steel, maraging steel, titanium alloys, aluminum alloys, and magnesium alloys. A part of the body member b1 may be made of a non-metal material. For example, a part of the body member b1 may be made of a carbon fiber reinforced resin. From the viewpoint of enabling welding between the body member b1 and the face member f1, the joint surface 116 of the body member b1 is preferably made of a metal. The body member b1 may be integrally formed as a single-piece member. Alternatively, the body member b1 may be formed by joining a plurality of members to each other. For example, the body member b1 may be formed by joining a member made of a metal to a member made of a carbon fiber reinforced plastic. In the present embodiment, the entirety of the body member b1 is made of a metal and is integrally formed as a single-piece member. There is no limitation on the method for producing the body member b1. In the present embodiment, the body member b1 is produced by casting (lost-wax precision casting).

Examples of general specifications for a driver head (including mini driver heads treated equally with a driver head) include the following (1a) to (1e):
(1a) a striking face forming a curved surface that is convex frontward;
(1b) a hollow structure;
(1c) a head volume of greater than or equal to 300 cm³ and less than or equal to 470 cm³;
(1d) a real loft angle of greater than or equal to 7 degrees and less than or equal to 13 degrees; and
(1e) presence of a crown.

Examples of club numbers of fairway wood type heads include 3-wood (W#3), 4-wood (W#4), 5-wood (W#5), 7-wood (W#7), 9-wood (W#9), 11-wood (W#11), and 13-wood (W#13). Examples of general specifications for a fairway wood type head include the following (2a) to (2e):
(2a) a striking face forming a curved surface that is convex frontward;
(2b) a hollow structure;
(2c) a head volume of greater than or equal to 100 cm³ and less than 300 cm³;
(2d) a real loft angle of greater than 13 degrees and less than or equal to 33 degrees; and
(2e) presence of a crown.

Examples of club numbers of hybrid type heads include 3-hybrid (H3), 4-hybrid (H4), 5-hybrid (H5), and 6-hybrid (H6). Examples of general specifications for a hybrid type head include the following (3a) to (3e):
(3a) a striking face forming a curved surface that is convex frontward;
(3b) a hollow structure;
(3c) a head volume of greater than or equal to 90 cm³ and less than or equal to 140 cm³;
(3d) a real loft angle of greater than or equal to 15 degrees and less than or equal to 33 degrees; and
(3e) presence of a crown.

Hybrid type heads are also referred to as utility type heads in Japan. Hybrid type heads may be classified as wood type or iron type. A hybrid type head classified as iron type includes a flat striking face. In the present disclosure, “hybrid type head” can only refer to the wood type among hybrid type heads.

A head that includes a crown, has a loft angle (real loft angle) of greater than 13 degrees, and has a head volume of less than 300 cm³ can be classified as a fairway wood type head or a hybrid type head. A head that includes a crown and has a head volume of greater than or equal to 300 cm³ can be classified as a driver head. The ratio W1/W2 can be used to distinguish between a fairway wood type head and a hybrid type head. A double-pointed arrow W1 in FIG. 8 shows a width of the head in the face-back direction. A double-pointed arrow W2 in FIG. 8 shows a width of the head in the toe-heel direction. The ratio W1/W2 of a hybrid type head is less than 0.65. The ratio W1/W2 of a fairway wood type head is greater than or equal to 0.65.

Regarding the above-described embodiments, the following clauses are disclosed.

### [Clause 1]

A golf club head including:
a body member; and a face member, wherein
the body member includes an opening that is formed in a front portion of the body member, and a hosel portion that includes a hosel hole,
the face member is joined to the body member to cover the opening of the body member,
the face member includes a striking face region that includes a sweet spot, and a peripheral region that surrounds an entirety of the striking face region,
the striking face region constitutes a curved surface that is convex frontward and that has a radius of curvature of greater than or equal to 200 mm,
the peripheral region of the face member includes a neck region that forms a heel-side portion of the peripheral region, that extends continuously from the striking face region, and that has a curved shape that is convex frontward, and
in a horizontal cross section that passes through the sweet spot and that is taken when the golf club head is in a reference state, a distance in a toe-heel direction between a toe-most point of the striking face region and a center line of the hosel hole is defined as a length L, a length of the striking face region in the toe-heel direction is defined as a length F, and a ratio of the length F to the length L is greater than or equal to 80%.

### [Clause 2]

The golf club head according to clause 1, wherein
the striking face region includes a heel-side edge at which the striking face region transitions into the neck region, and
in all horizontal cross sections passing through the heel-side edge and taken when the golf club head is in a reference state, a ratio of a distance in the toe-heel direction between the toe-most point of the striking face region and the heel-side edge to the length L is greater than or equal to 83%.

### [Clause 3]

The golf club head according to clause 2, wherein
a length of the heel-side edge of the striking face region in an up-down direction is defined as a length HH,
a length of the striking face region in the up-down direction in a vertical cross section passing through the sweet spot is defined as a length HC, and
a ratio of the length HH to the length HC is greater than or equal to 65%.

### [Clause 4]

The golf club head according to clause 3, wherein
the length HC is greater than or equal to 18 mm and less than or equal to 35 mm, and
the length L is greater than or equal to 75 mm and less than or equal to 90 mm.

### [Clause 5]

The golf club head according to any one of clauses 1 to 4, wherein
in a front elevation view of the golf club head as viewed from a face side in a face-back direction when the golf club head is in the reference state, the face member includes an intersection point between the center line of the hosel hole and the horizontal cross section that passes through the sweet spot.

### [Clause 6]

The golf club head according to any one of clauses 1 to 5, wherein
in a front elevation view of the golf club head as viewed from a face side in a face-back direction when the golf club head is in the reference state,
a portion of a contour line of the golf club head that is located on a crown side is defined as a crown-side contour line, and the crown-side contour line has a lowest point located on a heel side,
the neck region of the face member extends to reach a position located on the heel side relative to the lowest point, and
a portion of the neck region that is located on the heel side relative to the lowest point extends to reach a position located on an upper side relative to the lowest point.

### [Clause 7]

The golf club head according to any one of clauses 1 to 6, wherein the face member is joined to the body member by welding.

### [Clause 8]

The golf club head according to any one of clauses 1 to 7, wherein the golf club head is a hybrid type head or a fairway wood type head.

### LIST OF REFERENCE SYMBOLS

100, 200 Golf club head

104 Face portion

104a Striking face

106 Crown portion

108 Sole portion

110 Hosel portion

112 Hosel hole

114 Opening of the body member

116 Joint surface

118 Boundary between the body member and the face member (contour line of the face member)

120 Hosel inner wall portion

SS Sweet spot

z1 Hosel axis line

Rf Striking face region

Rs Peripheral region

Re Neck region

Re1 Inner wall front portion

f1, f2 Face member

b1, b2 Body member

C1 Hollow interior

k1 Outer edge of striking face

k2 Heel-side edge of the striking face region

The above descriptions are merely illustrative and various modifications can be made without departing from the principles of the present disclosure.

The terminology used in the description of the various described embodiments herein is for the purpose of describing particular embodiments only and is not intended to be limiting. The use of the terms “a”, “an”, “the”, and similar referents in the context of throughout this disclosure (especially in the context of the following claims) are to be construed to cover both the singular and the plural, unless otherwise indicated herein or clearly contradicted by context. As used throughout this disclosure, the word “may” is used in a permissive sense (i.e., meaning “having the potential to”), rather than the mandatory sense (i.e., meaning “must”). Similarly, as used throughout this disclosure, the terms “comprising,” “having,” “including,” and “containing” are to be construed as open-ended terms (i.e., meaning “including, but not limited to,”) unless otherwise noted.

Although the terms first, second, third, etc. may be used herein to describe various elements, components, regions, layers, sections, steps, processings, and/or operations, these elements, components, regions, layers, sections, steps, processings, and/or operations should not be limited by these terms. These terms may be only used to distinguish one element, component, region, layer, section, step, processing, or operation from another element, component, region, layer, section, step, processing, or operation. Terms such as “first,” “second,” and other numerical terms when used herein do not imply a sequence or order unless clearly indicated by the context. Thus, a first element, component, region, layer, section, step, processing, or operation discussed herein could be termed a second element, component, region, layer, section, step, processing, or operation without departing from the teachings of the example embodiments.

What is claimed is:

1. A golf club head comprising: a body member; and a face member, wherein
the body member includes an opening that is formed in a front portion of the body member, and a hosel portion that includes a hosel hole,
the face member is joined to the body member to cover the opening of the body member,
the face member includes a striking face region that includes a sweet spot, and a peripheral region that surrounds an entirety of the striking face region,
the striking face region constitutes a curved surface that is convex frontward and that has a radius of curvature of greater than or equal to 200 mm,
the peripheral region of the face member includes a neck region that forms a heel-side portion of the peripheral region, that extends continuously from the striking face region, and that has a curved shape that is convex frontward, and
in a horizontal cross section that passes through the sweet spot and that is taken when the golf club head is in a reference state, a distance in a toe-heel direction between a toe-most point of the striking face region and a center line of the hosel hole is defined as a length L, a length of the striking face region in the toe-heel direction is defined as a length F, and a ratio of the length F to the length L is greater than or equal to 80%.

2. The golf club head according to claim 1, wherein
the striking face region includes a heel-side edge at which the striking face region transitions into the neck region, and
in all horizontal cross sections passing through the heel-side edge and taken when the golf club head is in a reference state, a ratio of a distance in the toe-heel direction between the toe-most point of the striking face region and the heel-side edge to the length L is greater than or equal to 83%.

3. The golf club head according to claim 2, wherein
a length of the heel-side edge of the striking face region in an up-down direction is defined as a length HH,
a length of the striking face region in the up-down direction in a vertical cross section passing through the sweet spot is defined as a length HC, and
a ratio of the length HH to the length HC is greater than or equal to 65%.

4. The golf club head according to claim 3, wherein
the length HC is greater than or equal to 18 mm and less than or equal to 35 mm, and
the length L is greater than or equal to 75 mm and less than or equal to 90 mm.

5. The golf club head according to claim 1, wherein
in a front elevation view of the golf club head as viewed from a face side in a face-back direction when the golf club head is in the reference state, the face member includes an intersection point between the center line of the hosel hole and the horizontal cross section that passes through the sweet spot.

6. The golf club head according to claim 1, wherein
in a front elevation view of the golf club head as viewed from a face side in a face-back direction when the golf club head is in the reference state,
a portion of a contour line of the golf club head that is located on a crown side is defined as a crown-side contour line, and the crown-side contour line has a lowest point located on a heel side,
the neck region of the face member extends to reach a position located on the heel side relative to the lowest point, and
a portion of the neck region that is located on the heel side relative to the lowest point extends to reach a position located on an upper side relative to the lowest point.

7. The golf club head according to claim 1, wherein the face member is joined to the body member by welding.

8. The golf club head according to claim 1, wherein the golf club head is a hybrid type head or a fairway wood type head.

9. A golf club head comprising: a hollow interior; a body member; and a face member, wherein
the body member includes an opening that is formed in a front portion of the body member, and a hosel portion that includes a hosel hole,
the face member is joined to the body member to cover the opening of the body member,
the face member includes a striking face region that includes a sweet spot, and a peripheral region that surrounds an entirety of the striking face region,
the striking face region constitutes a curved surface that is convex frontward and that has a radius of curvature of greater than or equal to 200 mm,
the peripheral region of the face member includes a neck region that forms a heel-side portion of the peripheral region, that extends continuously from the striking face region, and that has a curved shape that is convex frontward,
the hosel portion includes a hosel inner wall portion that forms part of a wall defining the hosel hole, that faces the hollow interior, and that is located inside the golf club head, and
the neck region includes an inner wall front portion that is located on a front side relative to the hosel inner wall portion.

10. The golf club head according to claim 9, wherein a gap is formed between the inner wall front portion and the hosel inner wall portion.

11. The golf club head according to claim 9, wherein,
in a horizontal cross section that passes through the sweet spot and that is taken when the golf club head is in a reference state, a distance in a toe-heel direction between a toe-most point of the striking face region and a center line of the hosel hole is defined as a length L, a length of the striking face region in the toe-heel direction is defined as a length F, and a ratio of the length F to the length L is greater than or equal to 80%.

12. The golf club head according to claim 11, wherein
the striking face region includes a heel-side edge at which the striking face region transitions into the neck region, and
in all horizontal cross sections passing through the heel-side edge and taken when the golf club head is in a reference state, a ratio of a distance in the toe-heel direction between the toe-most point of the striking face region and the heel-side edge to the length L is greater than or equal to 83%.

13. The golf club head according to claim 12, wherein
a length of the heel-side edge of the striking face region in an up-down direction is defined as a length HH,
a length of the striking face region in the up-down direction in a vertical cross section passing through the sweet spot is defined as a length HC, and
a ratio of the length HH to the length HC is greater than or equal to 65%.

14. The golf club head according to claim 13, wherein
the length HC is greater than or equal to 18 mm and less than or equal to 35 mm, and
the length L is greater than or equal to 75 mm and less than or equal to 90 mm.

15. The golf club head according to claim 9, wherein
in a front elevation view of the golf club head as viewed from a face side in a face-back direction when the golf club head is in a reference state, the face member includes an intersection point between a center line of the hosel hole and a horizontal cross section that passes through the sweet spot.

16. The golf club head according to claim 9, wherein
in a front elevation view of the golf club head as viewed from a face side in a face-back direction when the golf club head is in a reference state,
a portion of a contour line of the golf club head that is located on a crown side is defined as a crown-side contour line, and the crown-side contour line has a lowest point located on a heel side,
the neck region of the face member extends to reach a position located on the heel side relative to the lowest point, and
a portion of the neck region that is located on the heel side relative to the lowest point extends to reach a position located on an upper side relative to the lowest point.

17. The golf club head according to claim 9, wherein the face member is joined to the body member by welding.

18. The golf club head according to claim 9, wherein the golf club head is a hybrid type head or a fairway wood type head.
